(19) United States
(12) Patent Application Publication
(10) Pub. No.: US 2012/0203444 A1
(43) Pub. Date: Aug. 9, 2012

(54) STARTUP CONTROL DEVICE FOR DIRECT-INJECTION INTERNAL COMBUSTION ENGINE

(75) Inventor: Seiji Niioka, Kariya-city (JP)

(73) Assignee: DENSO CORPORATION, Kariya-city (JP)

(21) Appl. No.: 13/364,434

(22) Filed: Feb. 2, 2012

(30) Foreign Application Priority Data
Feb. 8, 2011 (JP) 2011-24947

(51) Int. Cl. F02D 41/30

(52) U.S. Cl. 701/104

(57) ABSTRACT

A startup control device is applied to a fuel injection system having a starter motor, which rotates a crankshaft of a diesel engine, a fuel pump that is driven by the engine, a common rail that accumulates a high-pressure fuel pumped by the fuel pump, and an injector that injects the high-pressure fuel into a cylinder. The startup control device includes an ECU that determines whether the startability of the engine is deteriorated. If the ECU determines that the startability of the engine is deteriorated, the ECU decreases the amount of fuel supplied from the common rail to the injector during one revolution of the crankshaft.

### CROSS-REFERENCE TO RELATED APPLICATION

This application is based on Japanese Patent Application No. 2011-24947 filed on Feb. 8, 2011, the disclosure of which is incorporated herein by reference.

### FIELD OF THE INVENTION

The present invention relates to a startup control device for a direct-injection internal combustion engine in which a fuel injector directly injects high-pressure fuel stored in a common rail or other accumulator toward a combustion chamber.

### BACKGROUND OF THE INVENTION

The related art disclosed, for instance, in JP-2004-218643A (US-2004-0182367A1) monitors an injection pressure applied into an accumulator during a startup process. When the injection pressure reaches or rises above a predetermined threshold value, a fuel injector injects the fuel from the accumulator to a combustion chamber. This related art can start fuel injection in a state where the injection pressure is raised to a level at which the fuel readily ignites.

However, if the above-mentioned related art is used in a situation where the revolution speed of an internal combustion engine is low and the amount of fuel discharged from a fuel pump is small, a fuel pressure in the accumulator may decrease when fuel injection begins. Especially when, for instance, the amount of fuel leakage to a low-pressure side through a sliding clearance of the fuel injector increases with an increase in fuel temperature or an expected fuel discharge amount is not obtained due to the aging of the fuel pump, the fuel pressure in the accumulator remarkably decreases at the beginning of fuel injection. As a result, adequate fuel ignition performance cannot be maintained. This may result in the failure to sufficiently improve the startability of the internal combustion engine.

### SUMMARY OF THE INVENTION

The present invention has been made in view of the above circumstances and provides a startup control device that is capable of improving the startability of a direct-injection internal combustion engine even when the amount of fuel leakage increases or a fuel pump deteriorates.

In order to address the above problems, the present invention provides the following.

According to the present invention, there is provided a startup control device for a direct-injection internal combustion engine. The startup control device is applied to an accumulator fuel injection system that includes a rotating machine, a fuel pump, an accumulator, and a fuel injector. The rotating machine rotates a drive shaft of the engine when it starts up. The fuel pump is driven in accordance with the torque of the drive shaft. The accumulator stores a high-pressure fuel pumped from the fuel pump at a high pressure. The fuel injector receives the high-pressure fuel from the accumulator and injects the fuel into a cylinder. The startup control device includes a startability-determination-portion and a fuel-supply-control portion. The startability-determination-portion determines whether the startability of the engine is deteriorated. When the startability-determination portion determines that the startability of the engine is deteriorated, the fuel-supply-control portion decreases the amount of fuel that is supplied from the accumulator to the fuel injector when the drive shaft makes one revolution at the start of the engine.

The above configuration causes the rotating machine to rotate the drive shaft of the engine at the start of the engine, thereby driving the fuel pump in accordance with the torque of the drive shaft. The high-pressure fuel pumped from the fuel pump is then stored in the accumulator at the high pressure. Next, the high-pressure fuel supplied from the accumulator is injected into the cylinder by the fuel injector.

The startability-determination portion determines whether the startability of the engine is deteriorated. If, for instance, the last start of the engine was not completed or the amount of leakage from the fuel injector was increased, the startability-determination portion determines that the startability of the engine is deteriorated. When it is determined that the startability of the engine is deteriorated, the amount of fuel supplied from the accumulator to the fuel injector when the drive shaft makes one revolution at the start of the engine is decreased. Therefore, when the high-pressure fuel is pumped from the fuel pump to the accumulator at the start of the engine, a fuel pressure increase in the accumulator can be facilitated. This makes it possible to maintain adequate ignition performance of the fuel injected by the fuel injector, thereby improving the startability of the engine.

According to a second aspect of the present invention, the fuel-supply-control portion decreases the amount of fuel supplied from the accumulator to the fuel injector by decreasing the amount of fuel that is injected into the cylinder by the fuel injector during one combustion stroke.

The above-described configuration decreases the amount of fuel injected into the cylinder by the fuel injector during one combustion stroke. Therefore, the fuel pressure increase in the accumulator can be facilitated while the fuel is continuously injected by the fuel injector. This makes it possible not only to raise the revolution speed of the engine immediately after the injected fuel ignites, but also to shorten the start time of the engine.

According to a third aspect of the present invention, the engine includes multiple cylinders, each of which is provided with the fuel injector, and the fuel-supply-control portion decreases the amount of fuel supplied from the accumulator to the fuel injector by allowing only some of the cylinders to let the fuel injector inject the fuel during one revolution of the drive shaft.

The above-described configuration allows only some of the cylinders to let the fuel injector inject the fuel during one revolution of the drive shaft. Therefore, when the whole engine is considered, the amount of fuel supplied from the accumulator to the fuel injector can be significantly decreased. As a result, the fuel pressure increase in the accumulator can be further facilitated to further improve the startability of the engine.

According to a fourth aspect of the present invention, the engine includes multiple cylinders, each of which is provided with the fuel injector, and the fuel-supply-control portion decreases the amount of fuel supplied from the accumulator to the fuel injector by decreasing the amount of fuel injected into the cylinder by the fuel injector during one combustion stroke when the total number of fuel injections performed by the fuel injector since the start of the engine is smaller than a predetermined number and by allowing only some of the cylinders to let the fuel injector inject the fuel during one revolution of the drive shaft when the total number of fuel injections is not smaller than the predetermined number.

The above-described configuration decreases the amount of fuel injected into the cylinder by the fuel injector during one combustion stroke when the total number of fuel injections performed by the fuel injector since the start of the engine is smaller than the predetermined number. Therefore, when the injected fuel ignites until the total number of fuel injections reaches the predetermined number, the start time of the engine can be shortened. When, on the other hand, the total number of fuel injections is not smaller than the predetermined number, only some of the cylinders are allowed to let the fuel injector inject the fuel during one revolution of the drive shaft. Therefore, if the startup of the engine is not completed until the total number of fuel injections reaches the predetermined number, the startability of the engine can be further improved. As a result, if the startability of the engine is significantly deteriorated, the engine can be started with increased certainty while shortening the start time of the engine.

According to a fifth aspect of the present invention, the fuel injection system includes a fuel temperature detection portion that detects the temperature of the high-pressure fuel, the engine includes multiple cylinders, each of which is provided with the fuel injector, and the fuel-supply-control portion decreases the amount of fuel supplied from the accumulator to the fuel injector by decreasing the amount of fuel injected into the cylinder by the fuel injector during one combustion stroke when the temperature of the high-pressure fuel, which is detected by the fuel temperature detection portion, is lower than a predetermined temperature and by allowing only some of the cylinders to let the fuel injector inject the fuel during one revolution of the drive shaft when the temperature of the high-pressure fuel is not lower than the predetermined temperature.

When the temperature of the high-pressure fuel supplied to the fuel injector rises, the viscosity of the fuel decreases to increase the amount of fuel leakage from the fuel injector. Therefore, when the temperature of the high-pressure fuel rises, the pressure of the high-pressure fuel in the accumulator is likely to decrease.

In the above respect, the above-described configuration decreases the amount of fuel injected into the cylinder by the fuel injector during one combustion stroke when the detected high-pressure fuel temperature is lower than the predetermined temperature. Therefore, if the amount of fuel leakage from the fuel injector is not increased, the start time of the engine can be shortened by continuously injecting the fuel with a fuel injection amount decreased. When, on the other hand, the high-pressure fuel temperature is not lower than the predetermined temperature, only some of the cylinders are allowed to let the fuel injector inject the fuel during one revolution of the drive shaft. Consequently, the startability of the engine can be further improved in a situation where the pressure of the high-pressure fuel in the accumulator is likely to decrease. As a result, if the startability of the engine is significantly deteriorated, the engine can be started with increased certainty while shortening the start time of the engine.

According to a sixth aspect of the present invention, if the last start of the engine was not completed, the startability-determination portion determines that the startability of the engine is deteriorated.

If, in the above-described configuration, the last start of the engine was not completed, the amount of fuel supplied from the accumulator to the fuel injector is decreased because it is determined that the startability of the engine is deteriorated. In this instance, the fuel pressure increase in the accumulator is facilitated to improve the startability of the engine. However, the increase in the revolution speed may be slowed down during the start of the engine due to a decrease in the amount of fuel injectable from the fuel injector. On the other hand, if the last start of the engine was completed, the amount of fuel supplied from the accumulator to the fuel injector does not decrease because it is determined that the startability of the engine is not deteriorated. As a result, the engine speed can be immediately raised by following a normal engine startup sequence when it is not necessary to decrease the amount of fuel supplied from the accumulator to the fuel injector.

According to a seventh aspect of the present invention, the fuel injection system includes a fuel pressure detection portion that detects the pressure of the high-pressure fuel. The startup control device further includes a fuel injection inhibition portion that, at the start of the engine, inhibits the fuel injector from injecting the fuel until the pressure of the high-pressure fuel, which is detected by the fuel pressure detection portion, rises above a predetermined pressure.

As mentioned above, the rotating machine rotates the crankshaft of the engine at the start of the engine so that the fuel pump is driven in accordance with the torque of the crankshaft. In the above-described configuration, the fuel pressure detection portion in the fuel injection system detects the pressure of the high-pressure fuel. Further, at the start of the engine, the fuel injector is inhibited from injecting the fuel until the detected pressure of the high-pressure fuel rises above the predetermined pressure. Therefore, at the start of the engine, the fuel injector can start injecting the fuel while the pressure of the high-pressure fuel is raised to the predetermined pressure. This makes it possible to further improve the startability of the engine.

According to an eighth aspect of the present invention, the fuel injection system includes a fuel pressure detection portion that detects the pressure of the high-pressure fuel, and the fuel-supply-control portion decreases the amount of fuel supplied from the accumulator to the fuel injector by an amount that increases with an increase in the degree of insufficiency of the pressure of the high-pressure fuel, which is detected by the fuel pressure detection portion, compared to a target pressure of the high-pressure fuel.

In the above-described configuration, the amount of fuel supplied from the accumulator to the fuel injector is decreased by an amount that increases with an increase in the degree of insufficiency of the detected pressure of the high-pressure fuel compared to the target pressure of the high-pressure fuel. Therefore, the amount of fuel supplied from the accumulator to the fuel injector is decreased by an amount that increases with an increase in the degree of insufficiency of the detected pressure of the high-pressure fuel compared to the target pressure of the high-pressure fuel, that is, with a decrease in the degree of startability of the engine. Hence, the startability of the engine can be improved in accordance with the degree of engine startability deterioration. This makes it possible to inhibit an excessive decrease in the amount of fuel supplied from the accumulator to the fuel injector, that is, an excessive decrease in the amount of fuel injected by the fuel injector. Consequently, the increase in the engine's revolution speed can be inhibited from slowing down.

According to a ninth aspect of the present invention, the fuel injection system includes an engine revolution speed detection portion that detects the revolution speed of the engine, and the fuel-supply-control portion decreases the amount of fuel supplied from the accumulator to the fuel injector by an amount that increases with a decrease in the revolution speed of the engine, which is detected by the engine revolution speed detection portion.

In the above-described configuration, the amount of fuel supplied from the accumulator to the fuel injector is decreased by an amount that increases with a decrease in the detected revolution speed of the engine. Therefore, the amount of fuel supplied from the accumulator to the fuel injector decreases with a decrease in the detected revolution speed of the engine, that is, with a decrease in the discharge amount of the fuel pump. Hence, the startability of the engine can be improved in accordance with the degree of engine startability deterioration. This makes it possible to inhibit an excessive decrease in the amount of fuel supplied from the accumulator to the fuel injector, that is, an excessive decrease in the amount of fuel injected by the fuel injector. Consequently, the increase in the engine's revolution speed can be inhibited from slowing down.

According to a tenth aspect of the present invention, the engine includes multiple cylinders, each of which is provided with the fuel injector, and the fuel-supply-control portion decreases the amount of fuel supplied from the accumulator to the fuel injector by allowing only some of the cylinders to let the fuel injector inject the fuel during one revolution of the drive shaft and, when decreasing the amount of fuel supplied from the accumulator to the fuel injector by an increased amount, decreases the number of cylinders allowing the fuel injector to inject the fuel.

In the above-described configuration, only some of the cylinders let the fuel injector inject the fuel during one revolution of the drive shaft. Therefore, when the whole engine is considered, the amount of fuel supplied from the accumulator to the fuel injector can be significantly decreased. Further, when the amount of fuel supplied from the accumulator to the fuel injector is to be decreased by an increased amount, the number of cylinders allowing the fuel injector to inject the fuel is decreased. Consequently, the startability of the engine can be considerably improved in a stepwise manner in accordance with the degree of engine startability deterioration.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a schematic diagram illustrating an accumulator fuel injection system;

FIG. 2 is a flowchart illustrating processing steps for startup control according to a first embodiment;

FIG. 3 is a flowchart illustrating processing steps for startup control according to a second embodiment;

FIG. 4 is a flowchart illustrating processing steps for startup control according to a third embodiment;

FIG. 5 is a flowchart illustrating processing steps for startup control according to a fourth embodiment;

FIG. 6 is a flowchart illustrating modified processing steps for startup control according to the first embodiment;

FIG. 7 is a flowchart illustrating modified processing steps for startup control according to the second embodiment;

FIG. 8 is a flowchart illustrating modified processing steps for startup control according to the third embodiment; and

FIG. 9 is a flowchart illustrating modified processing steps for startup control according to the fourth embodiment.

### DETAILED DESCRIPTION OF EMBODIMENTS

### First Embodiment

A first embodiment of the present invention will now be described with reference to the accompanying drawings. The first embodiment is implemented as an accumulator fuel injection system that supplies fuel to an automotive diesel engine and injects the fuel. The system directly injects high-pressure fuel (e.g., light oil at a fuel injection pressure of approximately 1800 atmospheres) into a cylinder of a diesel engine (direct-injection internal combustion engine) to burn the fuel.

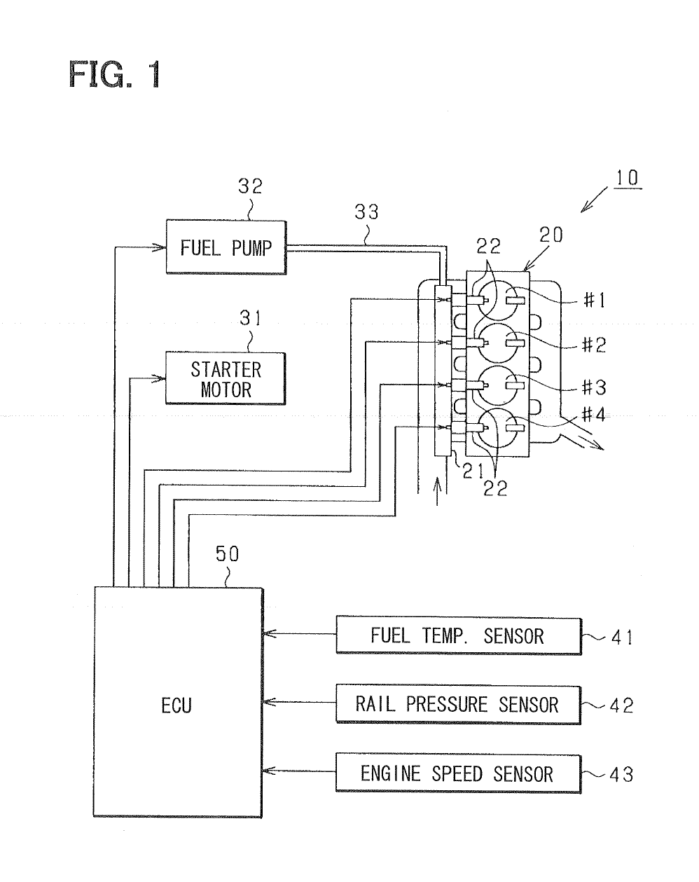

First of all, the accumulator fuel injection system will be outlined with reference to FIG. 1. In the present embodiment, it is assumed that a four-cylinder (multi-cylinder) engine for four-wheeled vehicles is used. The accumulator fuel injection system 10 is configured so that an electronic control unit (ECU) 50 acquires sensor outputs (detection results) from various sensors and controls the drive of a fuel supply device and other components in accordance with the sensor outputs.

From the fuel upstream side to the fuel downstream side, various components of a fuel supply system are a fuel tank, a fuel pump 32, and a common rail 21 (accumulator). The fuel tank and the fuel pump 32 are connected with a pipe that has a fuel filter.

The fuel pump 32 includes a low-pressure pump and a high-pressure pump. The low-pressure pump draws a fuel from the fuel tank. The high-pressure pump pressurizes and discharges the drawn fuel. The low- and high-pressure pumps are driven in accordance with the torque of a crankshaft (drive shaft) of the engine 20. The amount of fuel supplied to the high-pressure pump and the amount of fuel discharged from the fuel pump 32 are adjusted by a suction control valve that is disposed on the fuel intake side of the fuel pump 32.

The fuel in the fuel tank is drawn by the fuel pump 32 and pumped (pressurized and supplied) to the common rail 21 through a pipe 33 (high-pressure fuel path). The fuel pumped from the fuel pump 32 is accumulated in the common rail 21 at a high pressure.

Each of the first to fourth cylinders (cylinders #1, #2, #3, and #4) of the engine 20 is provided with a fuel injector 22. The high-pressure fuel stored in the common rail 21 at a high pressure is supplied to the injector 22 of each cylinder. The fuel pumped to the injector 22 of each cylinder is directly injected into each cylinder (combustion chamber) by each injector 22. The engine 20 is a four-stroke engine. More specifically, in each cylinder of the engine 20, a combustion cycle having four strokes (intake, compression, combustion, and exhaust) is successively executed at crank angle intervals of 720 degrees.

When the engine 20 is to start, a starter motor 31 (rotating machine) rotates the crankshaft. More specifically, a driver of the vehicle performs a startup procedure to supply electrical power from a battery to the starter motor 31, thereby allowing the torque of the starter motor 31 to rotate the crankshaft. A motor generator, which has the function of a motor and the function of a power generator, may be used as the rotating machine for rotating the crankshaft at engine startup.

The system 10 includes various sensors. More specifically, the common rail 21 is provided with a fuel temperature sensor 41 (fuel temperature detecting portion) for detecting the temperature Tf of the high-pressure fuel and a rail pressure sensor 42 (fuel pressure detecting portion) for detecting the pressure Pc of the fuel in the common rail 21. The crankshaft is provided with an engine revolution speed sensor 43 (engine-speed detecting portion) for detecting the revolution speed NE of the engine 20 in accordance with a crank angle signal that is generated at predetermined crank angle intervals.

The ECU 50 includes a well-known microcomputer, recognizes the operating state of the engine 20 and the request of a user in accordance with signals detected by the various sensors, and operates various actuators such as the injector 22 in accordance with the recognized engine operating state or user request. The microcomputer incorporated in the ECU 50 basically includes, for instance, a CPU (basic processing unit), which performs various computations; a RAM, which serves as a main memory for temporarily storing, for instance, data obtained in the middle of a computation and the result of the computation; a ROM, which serves as a program memory; a data storage memory (backup memory); and an input/output port, which inputs signals from and outputs signals to the outside. Various engine control programs, control maps, and the like are stored in the ROM. Design data about the engine 20, various other control data, and the like are stored in the data storage memory.

The ECU 50 provides feedback control of the drive of the fuel pump 32 so that the fuel pressure Pc detected by the rail pressure sensor 42 agrees with a target pressure Pct. An optimum target pressure Pct suitable, for instance, for each operating state of the engine 20 is preset in accordance with the results of experiments or the like. Further, the ECU 50 executes a program stored in the ROM to successively provide fuel injection control over the injector 22 of each cylinder of the engine 20 at predetermined crank angles. In fuel injection control, for example, the amount of fuel injected by each injector 22 and the timing of fuel injection are controlled in accordance with a current engine operating state. According to the present embodiment, when the computer determines that the startability of the engine 20 is deteriorated, the amount of fuel supplied from the common rail 21 to each injector 22 during one revolution of the crankshaft is decreased.

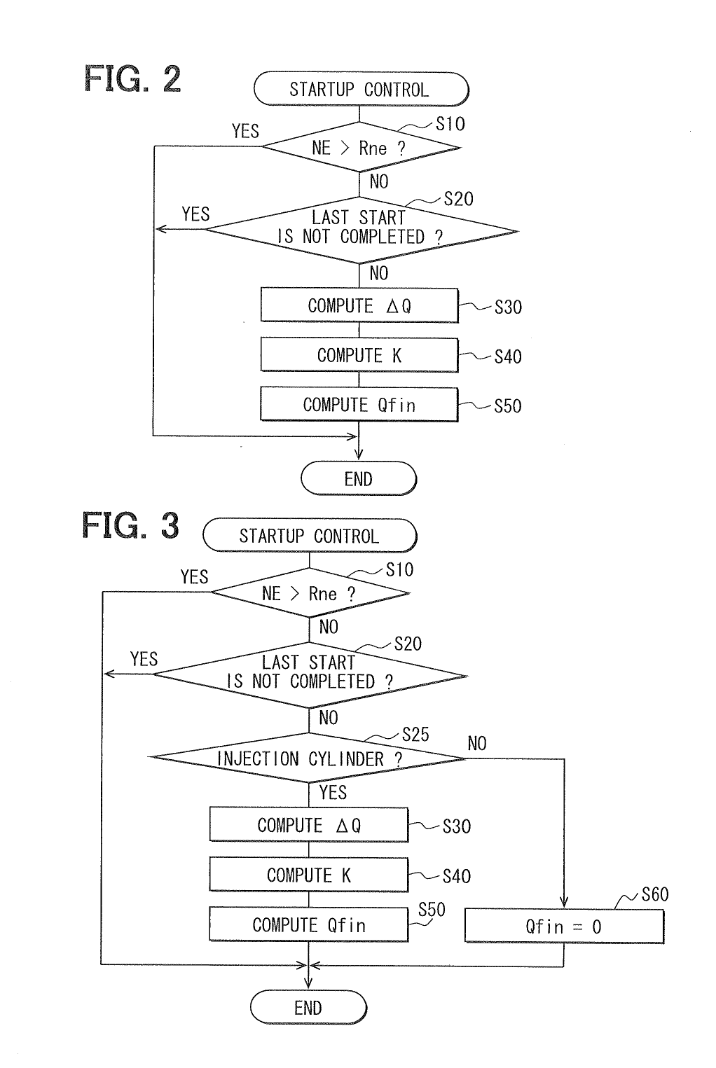

FIG. 2 is a flowchart illustrating a processing for startup control according to the present embodiment. At the start of the engine 20, the ECU 50 repeatedly performs a series of processing shown in FIG. 2 for all cylinders at predetermined crank angles.

Instep S10, the computer determines whether the revolution speed NE of the engine 20 is higher than a determination value Rne. More specifically, the computer determines whether the engine speed NE detected by the engine speed sensor 43 is higher than the determination value Rne. The determination value Rne is a value (e.g., 200 rpm) for determining whether the startup control processing should be completed to switch to a normal startup control. This determination value Rne is lower than a determination value Rnen (e.g., 500 rpm) for determining that startup is completed in the normal startup control. In other words, the determination value Rne is set to a value at which a first fuel combustion in the engine 20 can be detected.

When it is determined in step S10 that the revolution speed NE of the engine 20 is higher than the determination value Rne (S10: YES), the series of processing comes to an end (END). As a result, the amount of fuel supplied from the common rail 21 to each injector 22 does not decrease so that the injector 22 injects a regular amount of fuel to start the engine 20.

If, on the other hand, it is determined in step S10 that the revolution speed NE of the engine 20 is not higher than the determination value Rne (S10: NO), the procedure proceeds to step S20 in which the computer determines whether the last start of the engine 20 is not completed. In other words, the computer determines whether the revolution speed NE is lower than the determination value Rnen in the last start of the engine 20. The ECU 50 stores the result of whether the last start of the engine 20 is completed.

If it is determined in step S20 that the revolution speed NE of the engine 20 reached the determination value Rnen indicative of startup completion at the last start of the engine 20 (S20: YES), the series of processing steps comes to an end. In other words, if it is determined that the startability of the engine 20 is not deteriorated at its start, the engine 20 is started in the normal engine startup control without decreasing the amount of fuel supplied from the common rail 21 to each injector 22.

If, on the other hand, it is determined in step S20 that the revolution speed NE of the engine 20 did not reach the determination value Rne indicative of startup completion at the last start of the engine 20 (S20: NO), the procedure proceeds to step S30 in which a reduction amount ΔQ of the fuel injection amount is computed. In other words, if the computer determines that the startability of the engine 20 is deteriorated at its last start, the amount of fuel supplied from the common rail 21 to each injector 22 is decreased. The reduction amount ΔQ is an amount by which the amount of fuel injected by the injector 22 is decreased relative to a normal fuel injection amount during one combustion stroke of a target cylinder. More specifically, based on a map or a calculation formula predetermined by an experiment or the like, the reduction amount ΔQ is established larger as the fuel pressure Pc is less than the target pressure Pct. Further, based on a map or a calculation formula predetermined by an experiment, the reduction amount ΔQ is established larger as the revolution speed NE of the engine 20 detected by the speed sensor 43 becomes lower.

Then, the procedure proceeds to step S40 in which the computer computes a correction coefficient K for correcting the reduction amount ΔQ in accordance with the fuel temperature Tf. More specifically, based a map or calculation formula predetermined by an experiment, the correction factor K is established larger as the fuel temperature Tf detected by the fuel temperature sensor 41 becomes higher. In other words, the calculations are performed so that the correction coefficient K increases when the fuel temperature Tf rises to decrease the viscosity of the fuel.

Next, in step S50, a final injection amount Qfin is computed in accordance with a basic injection amount Qfinb, the reduction amount ΔQ, and the correction coefficient K. More specifically, the following equation is used to calculate the final injection amount Qfin. The basic injection amount Qfinb represents a basic amount of fuel to be injected by the injector 22 during one combustion stroke of the target cylinder and is calculated in accordance, for instance, with the operating state of the engine 20 by using a map or the like.

Qfin=Qfinb−K×AC)

The final injection amount Qfin is obtained by subtracting the product of the fuel reduction amount ΔQ and correction coefficient K from the basic injection amount Qfinb. Then, the procedure ends. The injector 22 of the target cylinder injects the final injection amount Qfin of fuel, which is calculated as described above. When the revolution speed NE is higher than the determination value Rnen in step S20, the computer determines that the startup of the engine 20 is completed, so that the procedure proceeds to a normal control.

The processing in step S20 corresponds to a startability-determination portion. The processings in steps S30 to S50 correspond to a fuel-supply-control portion.

The present embodiment, which has been described in detail above, provides the following advantages.

The ECU 50 determines whether the startability of the engine 20 is deteriorated. More specifically, if the last start of the engine 20 was not completed, the ECU 50 determines that the startability of the engine 20 is deteriorated. When it is determined that the startability of the engine 20 is deteriorated, the amount of fuel supplied from the common rail 21 to each injector 22 during one revolution of the crankshaft is decreased at the start of the engine 20. Therefore, when the high-pressure fuel is pumped from the fuel pump 32 to the common rail 21 at the start of the engine 20, an increase in the fuel pressure Pc in the common rail 21 can be facilitated. This makes it possible to maintain adequate ignition performance of the fuel injected by the injector 22, thereby improving the startability of the engine 20.

More specifically, the amount of fuel injected into the cylinder from the injector 22 during one combustion stroke is decreased. Therefore, the increase in the fuel pressure Pc in the common rail 21 can be facilitated while the fuel is continuously injected by the injector 22. This makes it possible not only to raise the revolution speed NE of the engine 20 immediately after the injected fuel ignites, but also to shorten the start time of the engine 20.

If the last start of the engine 20 was not completed, the amount of fuel supplied from the common rail 21 to each injector 22 decreases because the startability of the engine 20 is determined to be deteriorated. In this instance, the increase in the fuel pressure Pc in the common rail 21 is facilitated to improve the startability of the engine 20. However, as the amount of fuel injectable from each injector 22 decreases, the increase in the revolution speed NE may slow down during the start of the engine 20. If, on the other hand, the last start of the engine 20 was completed, the amount of fuel supplied from the common rail 21 to each injector 22 does not decrease because the startability of the engine 20 is determined to be maintained. As a result, the revolution speed NE of the engine 20 can be immediately raised by starting the engine 20 in a normal manner when it is not necessary to decrease the amount of fuel supplied from the common rail 21 to each injector 22.

The reduction amount ΔQ is more increased as the detected fuel pressure Pc is less than the target pressure Pct. Therefore, the amount of fuel supplied from the common rail 21 to each injector 22 is more decreased as the detected fuel pressure Pc is less than the target pressure Pct, that is, as the startability of the engine 20 is more deteriorated. Hence, the startability of the engine 20 can be improved in accordance with the deterioration degree in startability of the engine 20. This makes it possible to restrict an excessive decrease in the amount of fuel supplied from the common rail 21 to each injector 22, that is, an excessive decrease in the amount of fuel injected by each injector 22. Consequently, the increase in the revolution speed NE of the engine 20 can be restricted from slowing down.

The reduction amount ΔQ is increased with a decrease in the detected revolution speed NE of the engine 20. Therefore, the amount of fuel supplied from the common rail 21 to each injector 22 is more decreased as the detected revolution speed NE of the engine 20 is lower, that is, as the current discharge amount of the fuel pump 32 is smaller. Hence, the startability of the engine 20 can be improved in accordance with the deterioration degree in startability of the engine 20. This makes it possible to restrict an excessive decrease in the amount of fuel supplied from the common rail 21 to each injector 22, that is, an excessive decrease in the amount of fuel injected by each injector 22. Consequently, the increase in the revolution speed NE of the engine 20 can be restricted from slowing down.

In the above embodiment, based on a map or calculation formula previously obtained by an experiment, a calculation is performed in such a manner that the reduction amount ΔQ is more increased as the fuel pressure Pc becomes lower than the target pressure Pct. Further, based on a map or a calculation formula previously obtained by an experiment, the reduction amount ΔQ is established larger as the revolution speed NE of the engine 20 detected by the speed sensor 43 becomes lower. Alternatively, however, a fixed value previously obtained by an experiment or the like may be used as the reduction amount ΔQ.

### Second Embodiment

A second embodiment will be described hereinafter. The second embodiment will be described mainly with reference to the differences from the first embodiment. The system configuration shown in FIG. 1 applies not only to the first embodiment but also to the second embodiment.

In the second embodiment, the fuel injection is performed at the start of the engine 20 only in a part of the cylinders during one revolution of the crankshaft, instead of reducing the amount of fuel injected into the cylinder from the injector 22 during one combustion stroke. Therefore, if the startability of the engine 20 is determined to be deteriorated, the total amount of fuel supplied from the common rail 21 to four injectors 22 during one revolution of the crankshaft is decreased.

FIG. 3 is a flowchart illustrating processing for startup control. At the start of the engine 20, a series of processing shown in FIG. 3 is repeatedly performed for all cylinders at predetermined crank angles instead of the earlier-described processing shown in FIG. 2. The processing identical with those shown in FIG. 2 are designated by the same step numbers as in FIG. 2 and will not be redundantly described.

When it is determined in step S20 that the revolution speed NE of the engine 20 did not reach the determination value Rnen indicative of startup completion at the last start of the engine 20 (S20: NO), the procedure proceeds to step S25 in which the computer determines whether an subject cylinder of this processing is an injection cylinder in which a fuel injection is performed. For instance, the first cylinder is defined as a non-injection cylinder in which no fuel injection is performed, and the second to the fourth cylinder are defined as injection cylinders in which the fuel injection is performed. In step S25, the computer determines whether the subject cylinder is one of the second to the fourth cylinder.

When the answer is YES in step S25, the procedure proceeds to steps S30 to S50, which are described above. That is, the reduction amount ΔQ is computed in step S30. The correction factor K is computed in step S40. Then, in step S50, the final injection amount Qfin is computed in accordance with the basic injection amount Qfinb, the reduction amount ΔQ, and the correction factor K. As a result, the injector 22 injects the calculated final injection amount Qfin of fuel into the subject cylinders.

When the answer is NO in step S25, the procedure proceeds to step S60 in which the final injection amount Qfin is set to “0 (zero)” That is, in the non-injection cylinder, no fuel injection is performed.

The second embodiment, which has been described in detail above, provides the same advantages as the first embodiment except for the following point.

While the crankshaft makes one revolution, only three (some) of the four (multiple) cylinders permit the injector 22 to inject the fuel. Therefore, when the whole engine 20 is considered, the total amount of fuel supplied from the common rail 21 to a total of four injectors 22 can be significantly decreased. As a result, the increase in the fuel pressure Pc in the common rail 21 can be more facilitated to further improve the startability of the engine 20.

In the second embodiment, a fixed value previously obtained by an experiment may be used as the reduction amount ΔQ. The number of injection cylinders where a fuel injection is performed may be decreased as the fuel pressure Pc detected by the sensor 42 becomes lower than the target pressure Pct. Also, as the revolution speed NE of the engine 20 becomes lower, the number of injection cylinders where a fuel injection is performed may be decreased.

In the above-described configuration, with respect to only a part of the cylinders, the injector 22 injects the fuel during one revolution of the crankshaft. Therefore, when the whole engine 20 is considered, the amount of fuel supplied from the common rail 21 to the injector 22 can be significantly decreased. Further, as the amount of fuel supplied from the common rail 21 to the injector 22 is decreased, the number of cylinders where the injector 22 injects the fuel is decreased. Consequently, the startability of the engine 20 can be considerably improved in a stepwise manner in accordance with the deterioration degree in startability of the engine 20. When the injected fuel ignites at least once, the startability of the engine 20 can be improved because the revolution speed NE of the engine 20 greatly rises,

### Third Embodiment

A third embodiment of the present invention will now be described. The third embodiment will be described mainly with reference to the differences from the first and second embodiments. The system configuration shown in FIG. 1 applies not only to the first embodiment but also to the third embodiment.

If, during the start of the engine 20, the total number of fuel injections performed by the injector 22 since the beginning of engine startup is smaller than a determination value Ri, the amount of fuel injected into each cylinder from the injector 22 during one combustion stroke is reduced. On the other hand, if the total number of fuel injections performed by the injector 22 is not smaller than the determination value Ri, the injector 22 inject the fuel toward only a part of the cylinders during one revolution of the crankshaft.

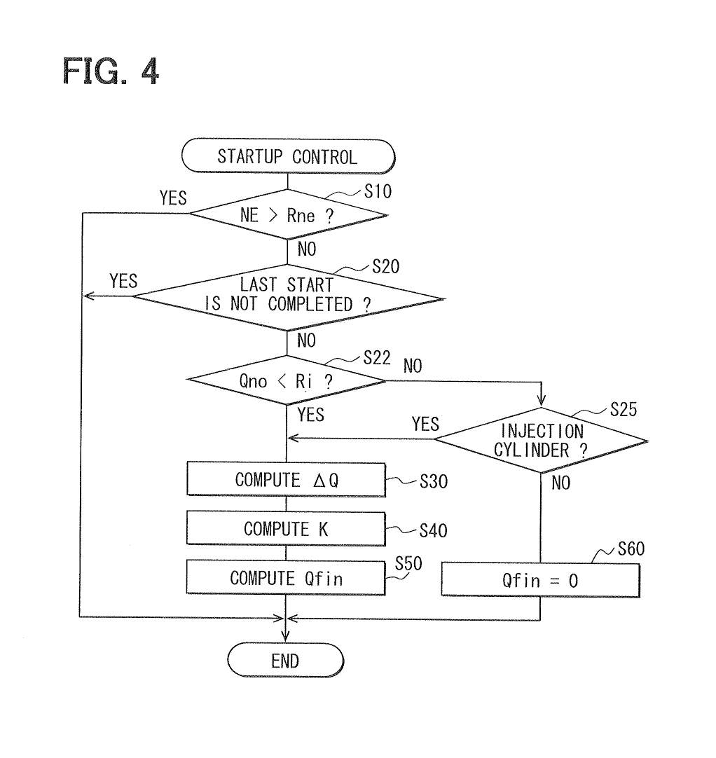

FIG. 4 is a flowchart illustrating a processing for startup control. At the start of the engine 20, the ECU 50 repeatedly performs a processing shown in FIG. 4 for all cylinders at predetermined crank angles. The processing identical with those shown in FIG. 3 are designated by the same step numbers as in FIG. 3 and will not be redundantly described.

Specifically, when it is determined in step S20 that the revolution speed NE of the engine 20 did not reach the determination value Rnen indicative of startup completion at the last start of the engine 20 (S20: NO), the procedure proceeds to step S22 in which the computer determines whether the total number of fuel injections Qno performed by the four (all) injectors 22 since the beginning of startup of the engine 20 is less than the determination value Ri. The determination value Ri represents the number of fuel injections at which fuel combustion is expected to occur in the engine 20 when the amount of fuel injected into the cylinder from the injector 22 during one combustion stroke is decreased. For example, the determination value Ri is set to be within a range between 4 and 6 (this range corresponds to two to three crankshaft revolutions).

If it is determined in step S22 that the total number of fuel injections Qno performed by the four injectors 22 since the beginning of startup of the engine 20 is smaller than the determination value Ri (S22: YES), the procedure proceeds to steps S30 to S50. The reduction amount ΔQ is computed in step 330. Next, the correction coefficient K is computed in step S40. In step S50, the final injection amount Qfin is computed in accordance with the basic injection amount Qfinb, the reduction amount ΔQ, and the correction factor K. As a result, the injectors 22 inject the calculated final injection amount Qfin of fuel.

When it is determined in step S22 that the total number of fuel injections Qno performed by the four injectors 22 since the beginning of startup of the engine 20 is not smaller than the determination value Ri (S22: NO), the procedure proceeds to step S25 in which the computer determines whether a subject cylinder is the injection cylinder in which the fuel injection will be performed. In step S25, the computer determines whether the subject cylinder is one of the second to the fourth cylinder.

When the answer is YES in step S25, the procedure proceeds to steps S30 to S50, which are described above. That is, the reduction amount ΔQ is computed in step S30. The correction factor K is computed in step S40. Then, in step S50, the final injection amount Qfin is computed in accordance with the basic injection amount Qfinb, the reduction amount ΔQ, and the correction factor K. As a result, the injector 22 injects the calculated final injection amount Qfin of fuel into the subject cylinders.

When the answer is NO in step S25, the procedure proceeds to step S60 in which the final injection amount Qfin is set to “0 (zero)” That is, in the non-injection cylinder, no fuel injection is performed.

The third embodiment, which has been described in detail above, provides the same advantages as the first and second embodiments except for the following point.

If the total number of fuel injections performed by the injector 22 since the beginning of startup of the engine 20 is smaller than the determination value Ri, the amount of fuel injected into the cylinder from the injector 22 during one combustion stroke is decreased. Therefore, when the injected fuel ignites before the total number of fuel injections reaches the determination value Ri, the start time of the engine 20 can be shortened. If the total number of fuel injections is not smaller than the determination value Ri, the fuel injection is performed with respect to only three (some) of the four (multiple) cylinders during one revolution of the crankshaft. Therefore, if the start of the engine 20 is not completed before the total number of fuel injections reaches the determination value Ri, the startability of the engine 20 can be further improved. As a result, even if the startability of the engine 20 is significantly deteriorated, the engine 20 can be started certainly while shortening the start time of the engine 20.

In the above embodiment, when it is determined that the subject cylinder is the injection cylinder, the basic injection amount Qfinb may defined as the final injection amount Qfin. In this case, the first and the fourth cylinders may be defined as the non-injection cylinders and the third and the second cylinders may be defined as the injection cylinders.

### Fourth Embodiment

A fourth embodiment of the present invention will be described hereinafter. The fourth embodiment will be described mainly with reference to the differences from the first and second embodiments. The system configuration shown in FIG. 1 applies not only to the first embodiment but also to the fourth embodiment.

If, during the start of the engine 20, the fuel temperature Tf detected by the fuel temperature sensor 41 is lower than a determination value Rf, the amount of fuel injected into each cylinder from the injector 22 during one combustion stroke is reduced. If the fuel temperature Tf is not lower than the determination value Rf, the fuel injection is performed in a part of cylinders during one revolution of the crankshaft.

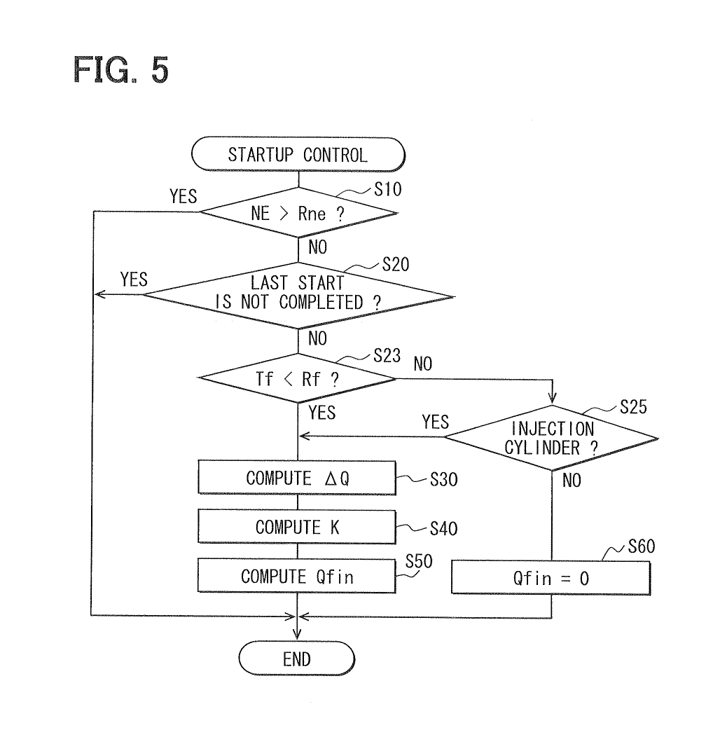

FIG. 5 is a flowchart illustrating processing steps for startup control. At the start of the engine 20, a series of processing shown in FIG. 5 is repeatedly performed for all cylinders at predetermined crank angles. The processings identical with those shown in FIG. 3 are designated by the same step numbers and will not be redundantly described.

When it is determined in step S20 that the revolution speed NE of the engine 20 did not reach the determination value Rnen indicative of startup completion at the last start of the engine 20 (S20: NO), the procedure proceeds to step S23 in which the computer determines whether the fuel temperature Tf is less than the determination value Rf. The determination value Rf represents the temperature at which an increase in the amount of fuel leakage from the injector 22 can be detected when the fuel temperature Tf rises. That is, at the determination value Rf, it can be detected that the fuel pressure Pc in the common rail 21 does not increase. For example, the determination value Rf is set to be 60° C.

When it is determined in step S23 that the fuel temperature Tf detected by the fuel temperature sensor 41 is lower than the determination value Rf (S23: YES), the procedure proceeds to steps S30 to S50. That is, the reduction amount ΔQ is computed in step S30. The correction factor K is computed in step S40. Then, in step S50, the final injection amount Qfin is computed in accordance with the basic injection amount Qfinb, the reduction amount ΔQ, and the correction factor K. As a result, the injectors 22 inject the calculated final injection amount Qfin of fuel.

When it is determined in step S23 that the fuel temperature Tf detected by the fuel temperature sensor 41 is not lower than the determination value Rf (S23: NO), the procedure proceeds to step S25 in which it is determined whether a subject cylinder is the injection cylinder in which a fuel injection will be performed. As described above, the computer determines whether the subject cylinder is one of the second to the fourth cylinder.

When the answer is YES in step S25, the procedure proceeds to steps S30 to S50, which are described above. That is, the reduction amount ΔQ is computed in step S30. The correction factor K is computed in step S40. Then, in step S50, the final injection amount Qfin is computed in accordance with the basic injection amount Qfinb, the reduction amount ΔQ, and the correction factor K. As a result, the injector 22 injects the calculated final injection amount Qfin of fuel into the subject cylinders.

When the answer is NO in step S25, the procedure proceeds to step S60 in which the final injection amount Qfin is set to “0 (zero)”. That is, in the non-injection cylinder, no fuel injection is performed.

The fourth embodiment, which has been described in detail above, provides the same advantages as the first to third embodiments except for the following point.

When the detected fuel temperature Tf is lower than the determination value Rf, the amount of fuel injected into the cylinder from the injector 22 during one combustion stroke is decreased. Therefore, if the amount of fuel leakage from the injector 22 is not increased, the start time of the engine 20 can be shortened by continuously injecting the decreased amount of fuel. If the fuel temperature Tf is not lower than the determination value Rf, a fuel injection is performed in only three (some) of the four (multiple) cylinders during one revolution of the crankshaft. Therefore, the startability of the engine 20 can be further improved in a situation where the fuel pressure Pc in the common rail 21 is likely to decrease. As a result, even if the startability of the engine 20 is significantly deteriorated, the engine 20 can be started certainty while shortening the start time of the engine 20.

In the fourth embodiment, when it is determined that the subject cylinder is the injection cylinder, the basic injection amount Qfinb may be defined as the final injection amount Qfin. In this case, the first and the fourth cylinders may be defined as the non-injection cylinders and the third and the second cylinders may be defined as the injection cylinders.

### Other Embodiment

It is to be understood that the present invention is not limited to the embodiments described above. For example, the following modifications are applicable to the above-described embodiments.

In the first to fourth embodiments, at the start of the engine 20, it may be prohibited that the injector 22 injects the fuel until the fuel pressure Pc detected by the rail pressure sensor 42 rises above the determination value Rp, which corresponds to a process performed by a fuel injection inhibition portion. The determination value Rp is set to a pressure at which the startability of the engine 20 can be further improved by raising the fuel pressure Pc in the common rail 21 to a certain extent beforehand. In the above-described configuration, the injector 22 can start injecting the fuel at the start of the engine 20 while the fuel pressure Pc is raised to the determination value Rp. This makes it possible to further improve the startability of the engine 20. More specifically, the first to fourth embodiments may be modified as described below.

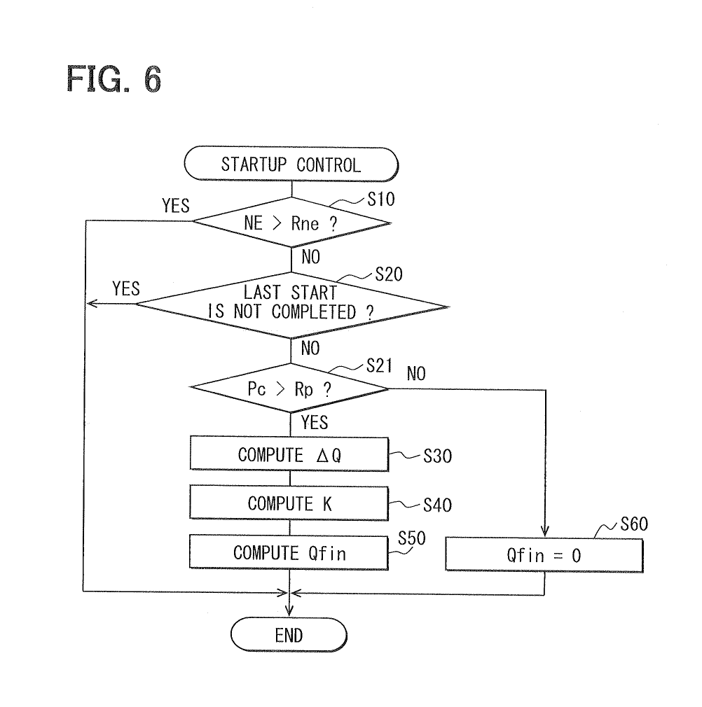

FIG. 6 is a flowchart illustrating modified processing for the startup control according to the first embodiment. At the start of the engine 20, the ECU 50 repeatedly performs a series of processing steps shown in FIG. 6 for all cylinders at predetermined crank angles.

When it is determined in step S20 that the revolution speed NE of the engine 20 did not reach the determination value Rnen indicative of startup completion at the last start of the engine 20 (S20: NO), the procedure proceeds to step S21 in which the computer determines whether the fuel pressure Pc is greater than the determination value Rp. When it is determined in step S21 that the fuel pressure Pc detected by the sensor 42 is greater than the determination value Rp (S21: YES), the procedure proceeds to steps S30 to S50. When the answer is NO in step S21, the procedure proceeds to step S60 in which the final injection amount Qfin is set to “0 (zero)”. That is, no fuel injection is performed.

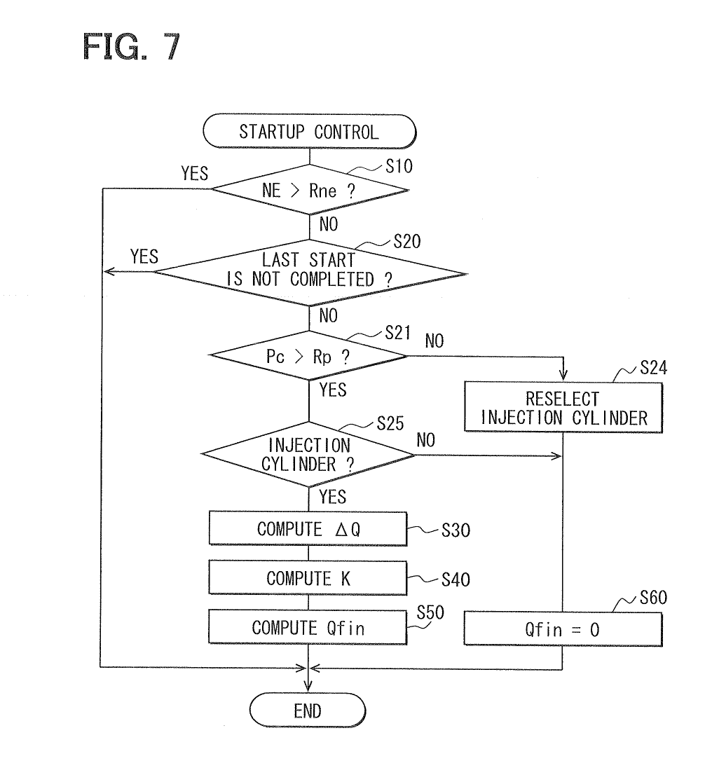

FIG. 7 is a flowchart illustrating modified processing steps for startup control according to the second embodiment. At the start of the engine 20, the ECU 50 repeatedly performs a series of processing steps shown in FIG. 7 for all cylinders at predetermined crank angles.

When it is determined in step S20 that the revolution speed NE of the engine 20 did not reach the determination value Rnen indicative of startup completion at the last start of the engine 20 (S20: NO), the procedure proceeds to step S21 in which the computer determines whether the fuel pressure Pc is greater than the determination value Rp. When it is determined in step S21 that the fuel pressure Pc detected by the sensor 42 is greater than the determination value Rp (S21: YES), the procedure proceeds to step S25. When it is determined in step S21 that the fuel pressure Pc is not higher than the determination value Rp (S21: NO), the procedure proceeds to step S24 in which the injection cylinder is reselected. More specifically, if the fuel pressure Pc is not higher than the determination value Rp, the number of the injection cylinders in which a fuel injection will be performed is reestablished depending on the current situation. Then, the procedure proceeds to step S60 in which the final injection amount Qfin is defined as “0 (zero)” so that the injector 22 does not inject the fuel.

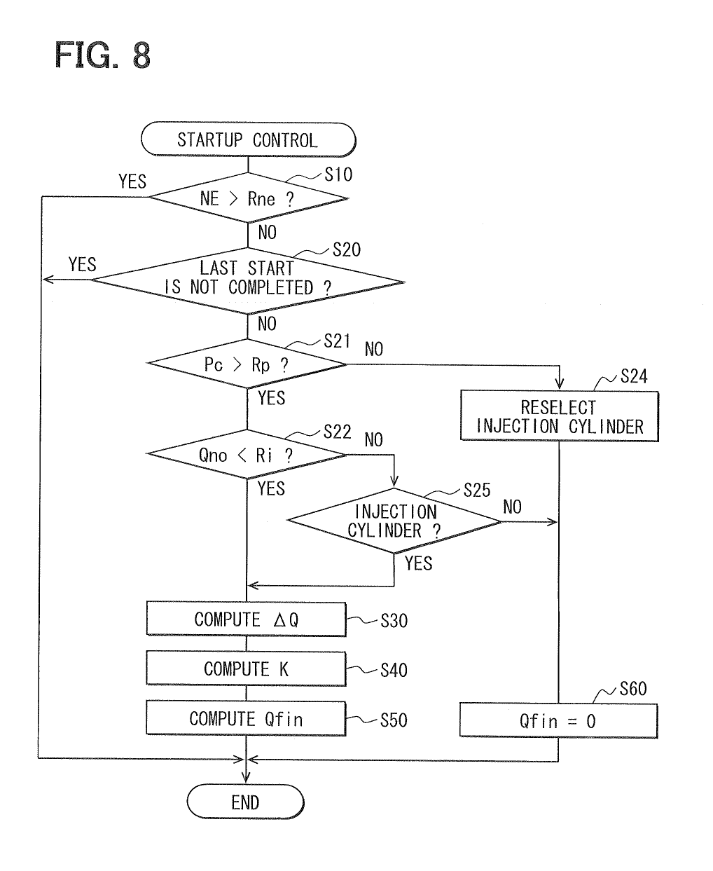

FIG. 8 is a flowchart illustrating modified processing steps for a startup control according to the third embodiment. At the start of the engine 20, the ECU 50 repeatedly performs a series of processing steps shown in FIG. 8 for all cylinders at predetermined crank angles.

When it is determined in step S20 that the revolution speed NE of the engine 20 did not reach the determination value Rnen indicative of startup completion at the last start of the engine 20 (S20: NO), the procedure proceeds to step 521 in which the computer determines whether the fuel pressure Pc is greater than the determination value Rp. When it is determined in step S21 that the fuel pressure Pc detected by the sensor 42 is greater than the determination value Rp (S21: YES), the procedure proceeds to step S22. When it is determined in step S21 that the fuel pressure Pc is not higher than the determination value Rp (S21: NO), the procedure proceeds to step S24 in which the injection cylinder is reselected. Then, the procedure proceeds to step 360 in which the final injection amount Qfin is defined as “0 (zero)” so that the injector 22 does not inject the fuel.

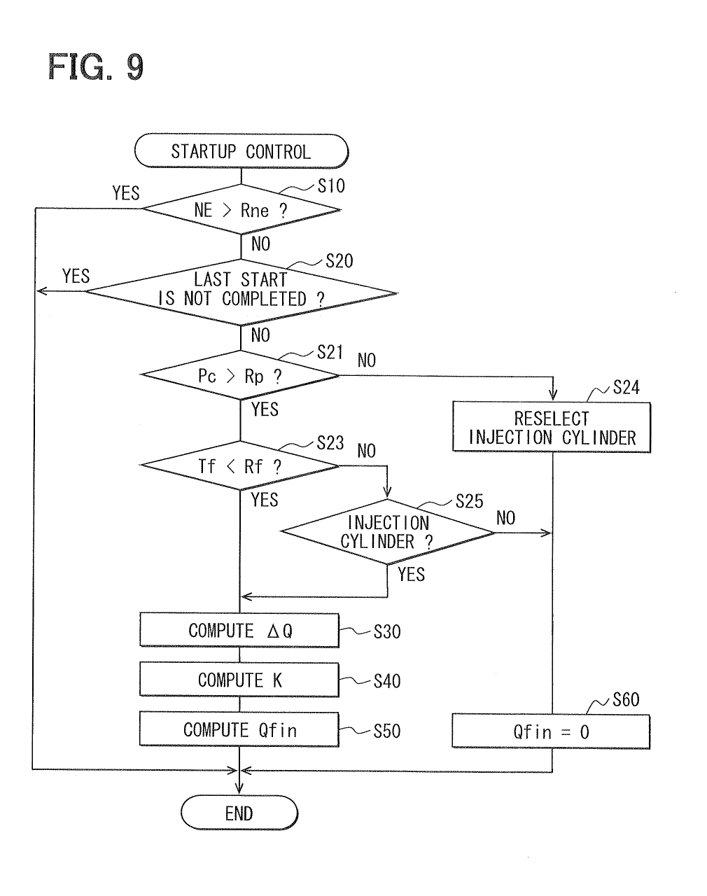

FIG. 9 is a flowchart illustrating modified processing steps for a startup control according to the fourth embodiment. At the start of the engine 20, the ECU 50 repeatedly performs a series of processing steps shown in FIG. 9 for all cylinders at predetermined crank angles.

When it is determined in step S20 that the revolution speed NE of the engine 20 did not reach the determination value Rnen indicative of startup completion at the last start of the engine 20 (S20: NO), the procedure proceeds to step S21 in which the computer determines whether the fuel pressure Pc is greater than the determination value Rp. When it is determined in step S21 that the fuel pressure Pc detected by the sensor 42 is greater than the determination value Rp (S21: YES), the procedure proceeds to step S23. When it is determined in step S21 that the fuel pressure Pc is not higher than the determination value Rp (S21: NO), the procedure proceeds to step S24 in which the injection cylinder is reselected. Then, the procedure proceeds to step S60 in which the final injection amount Qfin is defined as “0 (zero)” so that the injector 22 does not inject the fuel.

As a situation where the startability of the engine 20 is deteriorated, following situations can be detected. That is, it can be detected that the amount of fuel leakage from the injector 22 is increased. More specifically, it can be detected that the injector 22 is deteriorated or the fuel temperature Tf is higher than a predetermined temperature. Also, it can be detected that the fuel pump 32 is deteriorated or the torque of the starter motor 31 is decreased. Specifically, it can be detected that the starter motor 31 is deteriorated or a battery voltage is decreased. Further, in a situation where the start of the engine 20 should be prohibited in order to assure safety, the startup control according to the above embodiments and their modifications may be inhibited.

In an automobile that automatically starts and restarts the engine 20, startup control according to the above-described embodiments and their modifications may be exercised. In such an automobile, the engine 20 is often started while the fuel temperature Tf (the temperature of the engine 20) is high, that is, the amount of fuel leakage from the injector 22 is large. Therefore, the above-described startup control effectively improves the startability of the engine 20.

The present invention can be applied to a gasoline engine having a spark plug and a fuel injector.

What is claimed is:

1. A startup control device for a direct-injection internal combustion engine, which is applied to a fuel injection system including a rotating machine that rotates a crankshaft of the engine at a time of startup, a fuel pump that is driven in accordance with the torque of the crankshaft, an accumulator that accumulates a high-pressure fuel pumped from the fuel pump, and a fuel injector that injects the high-pressure fuel into a cylinder, the startup control device comprising:
a startability-determination portion which determines whether a startability of the engine is deteriorated; and
a fuel-supply-control portion which decreases, at a starting of the engine, an amount of the fuel supplied from the accumulator to the fuel injector during one revolution of the crankshaft when the startability-determination portion determines that the startability of the engine is deteriorated.

2. A startup control device according to claim 1, wherein
the fuel-supply-control portion decreases the amount of fuel supplied from the accumulator to the fuel injector by decreasing the amount of fuel that is injected into the cylinder by the fuel injector during one combustion stroke.

3. A startup control device according to claim 1, wherein
the engine includes a plurality of cylinders, each of which is provided with the fuel injector; and
the fuel-supply-control portion decreases the amount of the fuel supplied from the accumulator to the fuel injector by performing a fuel injection in a part of the cylinders during one revolution of the crankshaft.

4. A startup control device according to claim 1, wherein
the engine includes a plurality of cylinders, each of which is provided with the fuel injector;
the fuel-supply-control portion decreases the amount of fuel supplied from the accumulator to the fuel injector by decreasing the amount of fuel injected into the cylinder by the fuel injector during one combustion stroke when a total number of fuel injections performed by the fuel injector since a starting of the engine is smaller than a predetermined number, and
the fuel-supply-control portion decreases the amount of fuel supplied from the accumulator to the fuel injector by performing a fuel injection in a part of the cylinders during one revolution of the crankshaft when the total number of fuel injections is not smaller than the predetermined number.

5. A startup control device according to claim 1, wherein
the fuel injection system includes a fuel temperature detecting portion that detects the temperature of the high-pressure fuel;
the engine includes a plurality of cylinders, each of which is provided with the fuel injector;
the fuel-supply-control portion decreases the amount of fuel supplied from the accumulator to the fuel injector by decreasing the amount of fuel injected into the cylinder by the fuel injector during one combustion stroke when the temperature of the high-pressure fuel, which is detected by the fuel temperature detection portion, is lower than a predetermined temperature, and
the fuel-supply-control portion decreases the amount of fuel supplied from the accumulator to the fuel injector by performing a fuel injection in a part of the cylinders during one revolution of the drive shaft when the temperature of the high-pressure fuel is not lower than the predetermined temperature.

6. A startup control device according to claim 1, wherein
when a last starting of the engine is not completed, the startability-determination portion determines that the startability of the engine is deteriorated.

7. A startup control device according to claim 1, wherein
the fuel injection system includes a fuel pressure detecting portion that detects the pressure of the high-pressure fuel, the startup control device further comprising:
a fuel-injection-inhibition portion which, at a starting of the engine, inhibits the fuel injector from injecting the fuel until the pressure of the high-pressure fuel, which is detected by the fuel pressure detecting portion, rises above a predetermined pressure.

8. A startup control device according to claim 1, wherein
the fuel injection system includes a fuel pressure detection portion that detects the pressure of the high-pressure fuel; and
the fuel-supply-control portion decreases the amount of fuel supplied from the accumulator to the fuel injector by a specified decrease amount which is more increased as the fuel pressure detected by the fuel pressure detection portion becomes lower than a target pressure of the high-pressure fuel.

9. A startup control device according to claim 1, wherein
the fuel injection system includes an engine-speed detecting portion that detects the revolution speed of the engine; and
the fuel-supply-control portion decreases the amount of fuel supplied from the accumulator to the fuel injector by a specified increase amount which is more increased as the revolution speed of the engine becomes lower.

10. A startup control device according to claim 8, wherein
the engine includes a plurality of cylinders, each of which is provided with the fuel injector;
the fuel-supply-control portion decreases the amount of fuel supplied from the accumulator to the fuel injector by performing a fuel injection in a part of the cylinders during one revolution of the drive shaft; and
when decreasing the amount of fuel supplied from the accumulator to the fuel injector, the fuel-supply-control portion decreases the number of the cylinders in which a fuel injection is performed.
